(19) United States
(12) Patent Application Publication
(10) Pub. No.: US 2004/0052091 A1
(43) Pub. Date: Mar. 18, 2004

(54) Multi-purpose courtesy light device for seat belts

(76) Inventor: Peter Lee, Huntington Beach, CA (US)

Correspondence Address: Vic Y. Lin, MYERS, DAWES & ANDRAS LLP, Ste 1150, 19900 MacArthur Blvd., Irvine, CA, 92612, US

(21) Appl. No.: 10/242,974

(22) Filed: Sep. 13, 2002

(51) Int. Cl. F21L 4/00

(52) U.S. Cl. 362/570

(57) ABSTRACT

A courtesy light device includes a housing removably coupled to a waist strap of a standard car seat belt. Various securing mechanisms are provided for coupling the housing to the waist strap. A light source is included in a flip portion of the housing. The flip portion may be moved from a closed position to an open position by rotating the flip portion upwardly away from a base of the housing. Light is projected from the light source out of the flip portion. The light source may also be included in the base itself, in which case the flip portion may be omitted from the housing. The device may be detached from the seat belt, used as a flashlight, or as an emergency flashing light, and reattached when completed.

### BACKGROUND OF THE INVENTION

1. Field of the Invention

The invention relates generally to light devices and, more particularly, to courtesy lights in automobiles.

2. Description of Prior Art and Related Information

Trying to read material in an automobile can often times be a trying and treacherous endeavor. Many disadvantages are associated with conventional light fixtures within the cabin of a typical automobile. Such light fixtures are usually secured to the ceiling of the cabin, and are thus distant from the material or object of focus. The intensity of the light emitted from such devices are generally soft. Thus, the combination of distance and weak intensity leads to very poor lighting when a driver or passenger needs to focus on a particular object such as a map.

Furthermore, the usage of conventional reading lights within the automobile cabin is generally discouraged while the vehicle is moving because the light tends to distract other drivers, particularly at night. The distraction arises at least partially from the fact that the entire cabin is lit up as a result of the light shining from the cabin ceiling, even though the intensity of the lighting may be poor.

Some drivers keep flashlights stowed away in glove compartments or other areas within the cabin. An obvious disadvantage with this approach is that the driver or passenger must grapple around in search of the freely moving light. As with any object that is loosely stored in the cabin of a car, the object may be moved or simply lost. As a result, drivers may often divert their eyes from the road in search of a flashlight, thereby making themselves vulnerable to an accident.

### SUMMARY OF THE INVENTION

In accordance with the present invention, structures and associated methods are disclosed which address these needs.

In one aspect, a multi-purpose light device is adapted for use by a user wearing an automobile seat belt. The device comprises a base configured to receive at least one battery. A main body is pivotally coupled to the base and movable between a closed position and an open position. The main body comprises a first side generally facing the base in the closed position and an opposite, second side generally facing away from the base in the closed position. A light source is included in the main body and configured to shine light from the first side. A clip is configured to be secured to a vehicular seat belt.

The light source comprises a light-emitting diode. The clip may be integral with the base or removably coupled to the base. The clip defines a substantially rectangular, prismatic space for receiving the seat belt. The may be configured to be permanently secured to the seat belt, or removably secured to the seat belt. The main body may comprise a picture frame disposed on the second side. Alternatively, a picture frame may be included in the base.

The device may further comprise a manual switch included in the main body and configured to turn the light source on and off. The light source may also be configured to automatically turn on when the main body is not in the closed position and to automatically shut off when the main body is in the closed position.

The base comprises a front side, a rear side, and an axis that extends between the front side and the rear side. The base is preferably pivotable about the axis.

The device further comprises a recharging mechanism electrically coupled to a car battery and the battery housed in the base.

In another aspect, an automotive seat belt assembly is provided. The assembly comprises an automobile seat belt including a waist strap and a light device coupled to the waist strap. The light device comprises a light source housed in a main body. The main body is pivotally movable between a closed position and a fully open position. The main body comprises a first side generally facing the waist strap in the closed position and an opposite, second side generally facing away from the waist strap in the closed position.

The light device further comprises a clip coupled to the waist strap. The main body is configured to pivot upwardly from the closed position. The light source is configured to shine light from the first side. The main body includes a picture frame disposed on the second side. The light device may further comprise a switch to turn the light source on and off. The switch may be manually operable or configured to automatically shut off when the main body is in the closed position, and configured to turn on the main body is not in the closed position.

The assembly may further comprise an electrical charging mechanism including least one wire carried by the waist strap and electrically coupled to a car battery for providing electrical power to the light device. The electrical charging mechanism may recharge a battery housed in the light device, or directly power the light device without a battery. The electrical charging mechanism may comprise a charging station adapted to charge the light device.

The charging station comprises at least one station contact. The light device further comprises a base to which the main body is pivotally coupled. The base comprises a charging contact adapted to mate with the station contact when the light device is coupled to the charging station.

A multi-purpose light device is provided for use in connection with an automobile having a seat belt with a waist strap. The base has a front side and a rear side. The base is configured to house at least one battery. A light source is included in the base and adapted to shine light from the front side. A manual switch is provided to turn the light source on and off. A securing mechanism couples the base to the waist strap of the seat belt. The securing mechanism may comprise a slotted clip, a wire clip, a spring loaded clip, or a permanent clip. The base may be removably coupled to or integral with the securing mechanism. The securing mechanism may also comprise a buckle having a first aperture and a second aperture.

A courtesy light device is also provided for use within an automobile having a seat belt receptacle. The device comprises a housing, and a goose-neck stand telescopically and incrementally extendable from the housing. The goose-neck comprises a first end substantially disposed within the housing and an opposite second end. A light source is coupled to the second end of the goose-neck stand. The housing may be integral with the seat belt receptacle. The housing is preferably disposed adjacent to the seat belt receptacle.

A method of shining light in a cabin of an automobile having a seat belt with a waist strap is also provided. The method comprises coupling to the waist strap a housing having a first portion and a second portion, disposing a light source in the second portion, rotating the second portion away from the first portion, and projecting light outwardly from the second portion. Rotating the second portion away from the first portion comprises automatically turning on the light source.

The method further comprises rotating the second portion toward the first portion, automatically shutting off the light source when the second portion is rotated to a fully closed position. Alternatively, the method may comprise manually turning the light source on, and manually turning the light source off.

The method further comprises the steps of detaching the housing from the waist strap, reattaching the housing to the waist strap, rotating the second portion about an axis extending generally perpendicular to a rear side of the second portion, and electrically charging the light source with a car battery.

A further method is provided for shining light in a cabin of an automobile having a seat belt with a waist strap. The method comprises securing a light source to the waist strap, turning the light source on, projecting light outwardly from the waist strap, and turning the light source off. The method further comprises detaching the light source from the waist strap, projecting light in any direction, and reattaching the light source to the waist strap.

In summary, a courtesy light device includes a housing removably coupled to a waist strap of a standard car seat belt. Various securing mechanisms are provided for coupling the housing to the waist strap. A light source is included in a flip portion of the housing. The flip portion may be moved from a closed position to an open position by rotating the flip portion upwardly away from a base of the housing. Light is projected from the light source out of the flip portion. The light source may also be included in the base itself, in which case the flip portion may be omitted from the housing. The device may be detached from the seat belt, used as a flashlight, or as an emergency flashing light, and reattached when completed.

The invention, now having been briefly summarized, may be better visualized by turning to the following drawings wherein like elements are referenced by like numerals.

### BRIEF DESCRIPTION OF THE DRAWINGS

FIG. 1 is a front elevation view of a first preferred embodiment of a seat belt assembly according to the invention;

FIG. 2 is a top plan view of a first preferred multi-purpose light device according to the invention;

FIG. 3 is an exploded view of the first preferred light device;

FIG. 4 is an exploded view of a second preferred embodiment of a light device;

FIG. 5 is an exploded view of a third preferred embodiment of a light device;

FIG. 6 is an exploded view of a fourth preferred embodiment of a light device; and

FIG. 7 is a perspective view of a fifth preferred embodiment of a light device;

FIG. 8 is an exploded view of a sixth preferred embodiment of a light device;

FIG. 9 is a side view of a seventh preferred embodiment of a light device, illustrating the light device in a closed, retracted configuration;

FIG. 10 is a side view of the seventh preferred embodiment of the light device, illustrating the light device in an extended, operative configuration; and

FIG. 11 is a schematic view of a preferred light assembly including a charging station.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

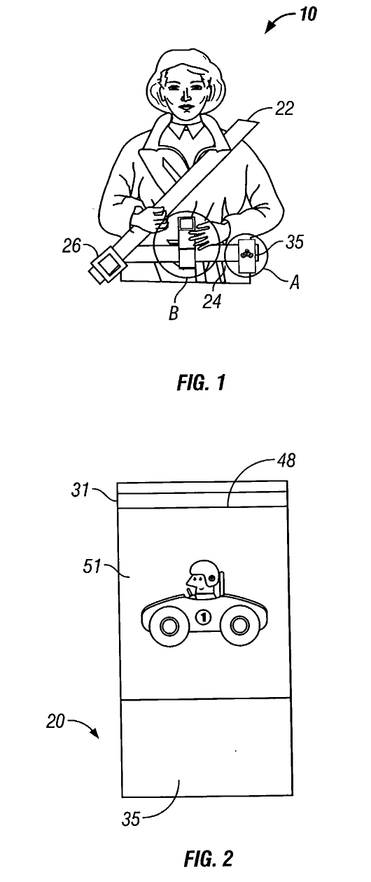

FIG. 1 is a front elevation view of a first preferred embodiment of a seat belt assembly 10 comprising a preferred multi-purpose light device 20 according to the invention. The seat belt assembly 10 may comprise a conventional seat belt having a shoulder strap 22, a waist strap 24 and a belt buckle 26 . The preferred multi-purpose light 20 is preferably coupled to the waist strap 24 and adapted to flip between a closed position A and a fully open position B. FIG. 2 is a front elevation view of the light 20 in the closed position A.

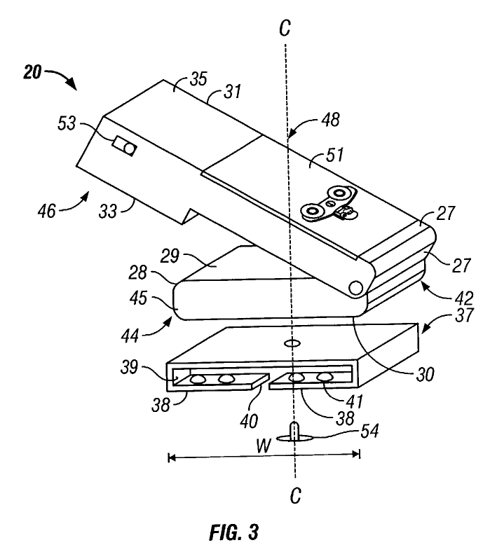

In FIG. 3, the device 20 comprises a housing 27. In the first preferred embodiment, the housing 27 comprises a first portion, or base, 28 configured to house one or more batteries, and a second portion, or main body, 31 that is pivotally coupled to the base 28. In FIGS. 1 and 3, the pivotable, or “flippable”, main body 31 comprises a first, or inner, side 33 that faces the waist strap 24 when the device 20 is in the closed position A, shown in FIG. 1, and an second, or outer, side 35 that faces away from the waist strap 24 when the device 20 is in the closed position A, also shown in FIG. 1. The base 28 may comprise a battery box having a front side 29 and a rear side 30. Thus, the base 28 and main body 31 collectively form the housing 27 that is adapted to be coupled to a waist strap as described further below.

A clip 37 serves to secure the device 20 to the waist strap 24. The clip 37 may be integral with or removably coupled to the base 28. In the illustrated embodiment, the clip 37 is coupled to the rear side 30 of the base 28. The clip 37 defines a substantially rectangular, prismatic space 39 that is adapted for receiving the waist strap 24. In particular, the clip 37 includes a pair of centrally extending arms 38 spaced apart from each other by a gap, or slot, 40 through which the waist strap may be inserted and removed. A plurality of protuberances, or bumps, 41 are provided on inner surfaces defining the space 39. The bumps 41 serve to provide friction against an inserted waist strap, thereby coupling the device 20 more securely to the waist strap.

Since the waist straps of conventional seat belts are generally standardized, it will be appreciated that the clip 37 is particularly configured to be coupled, or retrofitted onto, any waist strap of a standard seat belt. With the standard seat belt having a width of approximately 1⅞^{th} inches, the clip 37 may be configured to have an inner width W slightly less than the width of the waist strap such that the edges of the waist strap contact the inner surfaces defining the space 39.

Though the base 28 is shown in a generally horizontal position in FIG. 3, it will be appreciated that the base 28 has a top portion 42 and a bottom portion 44 as defined by the position of the device 20 in operation, as shown in FIG. 1. The main body 31 is preferably hinged to the sides 45 such that the main body 31 flips, or rotates, upwardly from the closed position, as shown in FIG. 1. A light source 46 is included in the main body 31 and disposed on the inner side 33. Thus, the source 46 shines light outwardly from the inner side 33. By being pivotally coupled to the sides 45 of the base 28, light is initially directed at the seat belt, then downwardly, and finally away from the user as the main body 31 is rotated. It will be appreciated that this pivoting action generally facilitates the light being shone downwardly. This is generally preferable for all users, especially the driver, as it allows the object of attention to be laid in the user's lap. As a result, the user need not raise the object of attention to eye level which might otherwise distract the user from watching the road.

The coupling of the light device 20 to the waist strap 24 is also preferable as it enables the object of attention to be placed closer to the light source 46, yielding improved visibility. Furthermore, the light source 46 preferably comprises a plurality of light-emitting diodes (LEDs) which provide brighter and better focused light than that found in common reading lights.

In FIG. 3, the clip 37 is illustrated as removable. It will be appreciated, therefore, that a user may remove the multi-purpose light device 20 from the waist strap 24 and use the device 20 in any manner desired. For example, the device 20 may be removed from the waist strap 24 and used as a flashlight. The user may get out of the vehicle and use the device 20, for example, to look at the engine or the trunk, or to change a tire. When the user is done with the device 20, the clip 37 allows the user to simply couple the device 20 back onto the waist strap 24, thereby minimizing any chance of the device 20 being lost. In FIGS. 2 and 3, the main body 31 further comprises a picture frame 48 adapted to display a picture 51 on the outer side 35. In the preferred embodiment shown in FIGS. 1-3, a manual switch 53 is provided to enable the user to turn the light source 46 on and off.

In FIG. 3, the base 28 may be configured to pivot or rotate with respect to the securing mechanism 37. In particular, the base 28 may be pivotable about an axis “C” that extends generally perpendicular to a plane defined by the base rear side 30. For example, a fastener 54 may be inserted through the securing mechanism 37 to rotatably engage the base 28. Thus, in the view shown in FIG. 2, the entire device 20 may be rotated in a clockwise direction “D” or a counterclockwise direction “E”.

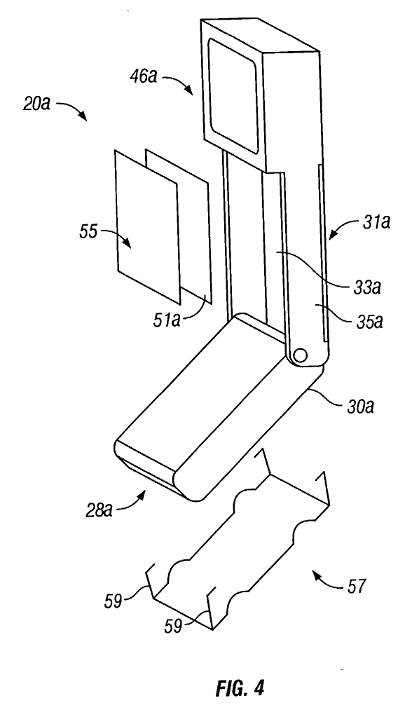

A second preferred embodiment of the light device is shown in FIG. 4 and designated generally by the reference numeral 20a. In this embodiment, elements of similar structure are designated by the same reference numerals followed by the lower case letter “a”. The main body 31a may be composed of a substantially transparent material. Instead of being disposed on the outer side 35a of the main body 31 a, it will be appreciated that a picture 51a may be disposed on the inner side 33a of the transparent main body 31a and thus be displayed through the transparent main body 31a. The picture 51a may be secured by a backing 55 which may be composed of mylar with adhesive, for example.

In the second preferred embodiment, the light source 46a may be configured to automatically switch on and off depending upon the position of the main body 31a. In particular, the light source 46a may be configured to shut off when the main body 31 a is in the closed position, and configured to turn on when the main body 31a is in any position other than the closed position. Thus, as soon as the main body 31a is rotated from the closed position, the light source 46a automatically turns on.

It is to be expressly understood that a variety of securing mechanisms may be employed to couple the lighting device to a waist strap of a seat belt. For example, in FIG. 4, the second preferred light device 20b comprises a wire clip 57 coupled to a rear side 30a of the base 28a. Configured to receive a waist strap of a standard automobile seat belt, the wire clip 57 includes a plurality of arms 59 adapted to sufficiently receive the waist strap while latching onto mating openings on rear side 30a.

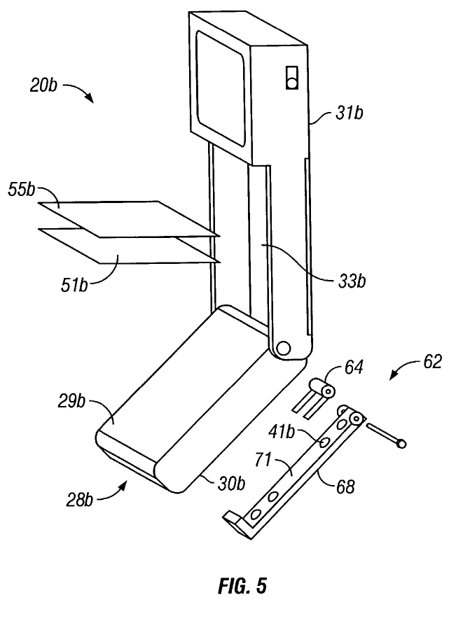

A further securing mechanism is shown in a third preferred embodiment of a light device 20b illustrated in FIG. 5. Elements of similar structure are designated by the same reference numerals followed by the lower case letter “b”. In this embodiment, the a spring loaded securing mechanism 62 is provided. In particular, a spring mechanism 64, such as a torsion spring, biases a flanged clip 68 toward a rear side 30b of a base 28b. Protuberances 41b may be provided on an inner surface 71 of the flanged clip 68.

Since a main body 31b may be composed of a substantially transparent material, it will be appreciated that a photograph 51b may be disposed on a front side 29b of the base 28b and secured by a transparent mylar backing 55b. A transparent mylar cover with adhesive 55b retains the photograph 51b in place. The photograph 51b can thus be displayed through the transparent mylar cover 55b and the main body 31b.

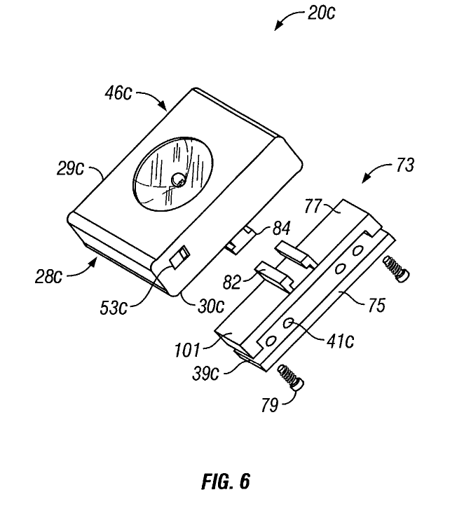

A fourth preferred embodiment of a light device 20c is illustrated in FIG. 6 wherein elements of similar structure are designated by the same reference numeral followed by the lower case letter “c”. In FIG. 6, the light device 20c comprises a securing mechanism 73 adapted to be secured to the waist strap of a standard seat belt at all times. In FIG. 6, the securing mechanism 73 comprises an inner portion 75 that is preferably fastened to an outer portion 77 by, for example, screws 79. When fastened, the inner portion 75 and outer portion 77 collectively define a substantially, rectangular prismatic space 39c for receiving a waist strap. Thus, the securing mechanism 73 cannot be removed without intentionally loosening the fasteners 79, thereby preventing any incidental dislodgment.

The securing mechanism 73 may be formed integrally with or separate from the remainder of the device 20. In the illustrated embodiment, the outer portion 77 of the securing mechanism 73 includes a track 82 configured to receive a corresponding key 84 disposed on a rear side 30c of the base 28c. In the fourth preferred embodiment 20c, the pivotable main body of previous embodiments is omitted. Instead, a light source 46c is included in the base 28c and configured to shine light outwardly from a front side 29c. A manual light switch 53c is provided to enable the user to turn the light on and off.

Since the base 28c is detachable from the securing mechanism 73, it will be appreciated that the base 28c, which includes the light source 46b, may serve as a flashlight. A user can remove the base 28c from the securing mechanism 73 and direct light upon anything desired. The user may even step out of the car and take the removed base 28c to use, for example, in searching a car trunk. Though the base 28c is detachable from the securing mechanism 73, chances of losing the base 28c are minimized as the securing mechanism 73 provides a home for retaining the base 28c. Furthermore, since the securing mechanism 73 is adapted to constantly remain on the waist strap, it serves as a reminder to the user who straps on the seat belt to reattach the base 28c.

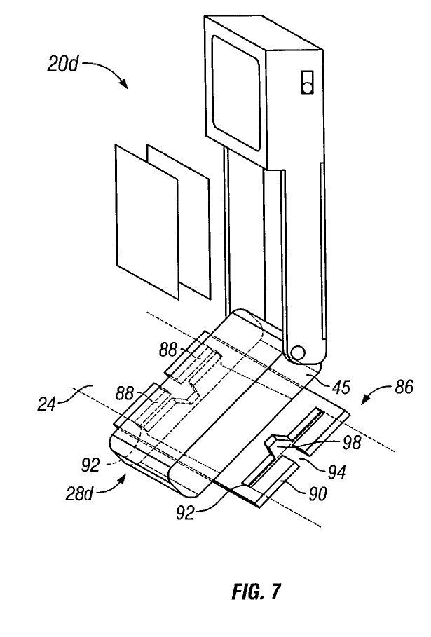

A fifth preferred embodiment of a light device 20d is illustrated in FIG. 7 wherein elements of similar structure are designated by the same reference numeral followed by the lower case letter “d”. In the fifth preferred embodiment 20d, a securing mechanism 86 is preferably formed integrally with a base 28d. In particular, the securing mechanism 86 comprises a first pair of arms 88 and a second pair of arms 90. Each pair defines a substantially rectangular aperture 92 with a gap 94 for insertion and removal of a waist strap 24. Each pair of arms 88, 90 protrudes laterally from the sides 45 of the base 28d such that the apertures 92 are disposed laterally of the base sides 45. The securing mechanism 86 thus preferably functions as a buckle wherein a waist strap is threaded through both apertures 92 to secure the light device 20d. A notch 98 is formed in the aperture 92 to accommodate any central protrusions found in conventional waist straps.

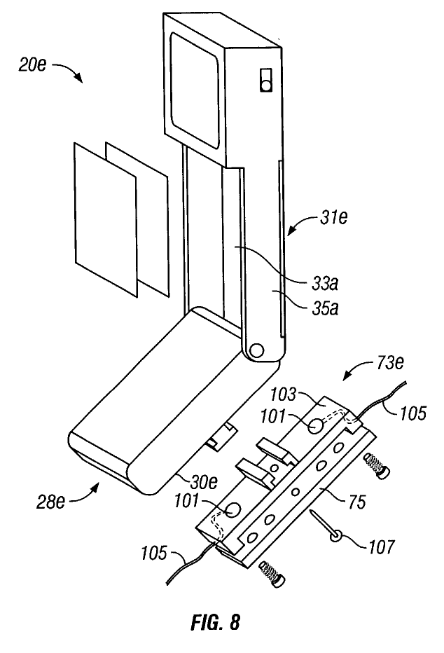

A sixth preferred embodiment of a light device 20e is illustrated in FIG. 8 wherein elements of similar structure are designated by the same reference numeral followed by the lower case letter “e”. In FIG. 8, the light device 20e comprises a main body 31 e pivotable with respect to a base 28e, similar to those of the above discussed embodiments. The base 28e is removably coupled to a securing mechanism 73e similar to the mechanism 73 shown in FIG. 6, except that the securing mechanism 73e comprises a clip that also facilitates in providing electrical power to the device 20e.

In particular, the securing mechanism 73e comprises electrical contacts 101 disposed on an outer surface 103 of the clip 73e. Corresponding contacts are disposed on a rear side 30e of the base 28e and configured to recharge a battery housed therein. The contacts 101 are electrically coupled to wires 105 which may be embedded or otherwise carried by the seat belt for connection to a car battery. Therefore, it will be appreciated that the embodiment 20e may be provided as either a rechargeable device or as a self-charging, battery-less device. Where a battery is housed within the base 28e, the battery may be recharged by the electrical source. In such an embodiment, the base 28e may be detachable from the securing mechanism 73e. Alternatively, the battery may be omitted altogether as electrical power for the device may simply be provided by the car battery which is electrically coupled to the device 20e by the wires 105 and contacts 101. In such a case, the base 28e is preferably secured to the securing mechanism 73e at all times, though the base 28e may nonetheless be pivotable with respect to the securing mechanism 73e.

The securing mechanism 73e also comprises a locking pin 107 to pin down or pierce the waist strap so that the device 20e may be fixed at a precise location on the waist strap and any incidental movement along the strap is prevented.

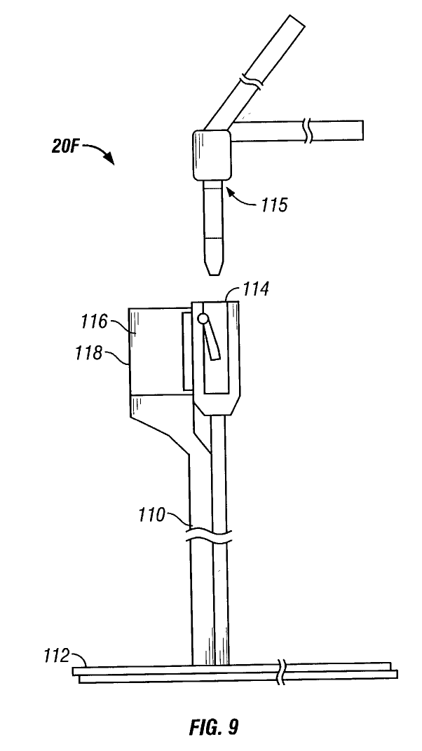

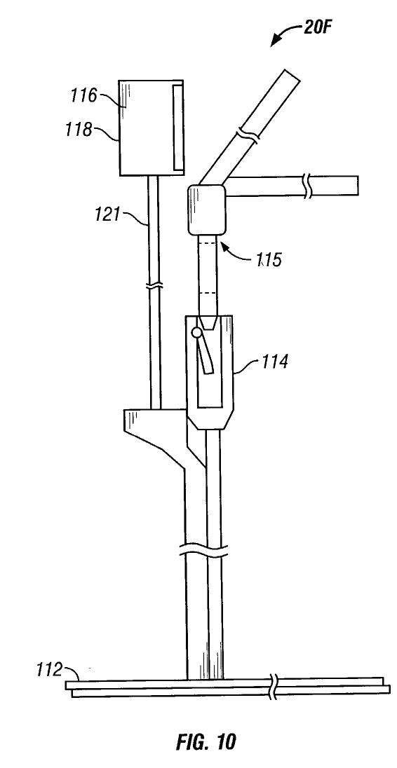

FIGS. 9 and 10 illustrate a seventh preferred embodiment of a light device 20f. The device 20f comprises a housing 110 that may be coupled to a car floor 112 or other mechanical supports. The device 20f is preferably configured to extend vertically from the floor 112 or from other similar supports. The housing 110 is preferably disposed adjacent to or integrated with a seat belt receptacle 114 that is configured to receive a standard belt buckle 115. A light source 116 is disposed within an enclosure, or body 118. The body 118 is coupled to a stand 121 that is telescoped within the housing 110. The stand 121 preferably comprises a “goose-neck” stand that is malleable, but sufficiently rigid to hold its shape after being manipulated by the user.

When inoperative, the stand 121 may be telescoped within the housing 110 as shown in FIG. 9. In use, the body 118 is pulled upwardly and away from the housing 110. The stand 121 is thus incrementally and telescopically extendable from the housing 110. With the aid of the stand 121, the body 118 may be bent and angled to shine light in any desired direction. A plurality of mechanisms, such as a ratchet mechanism, for example, may be provided to releasably lock the stand 121 at particular points along the height of the housing 110.

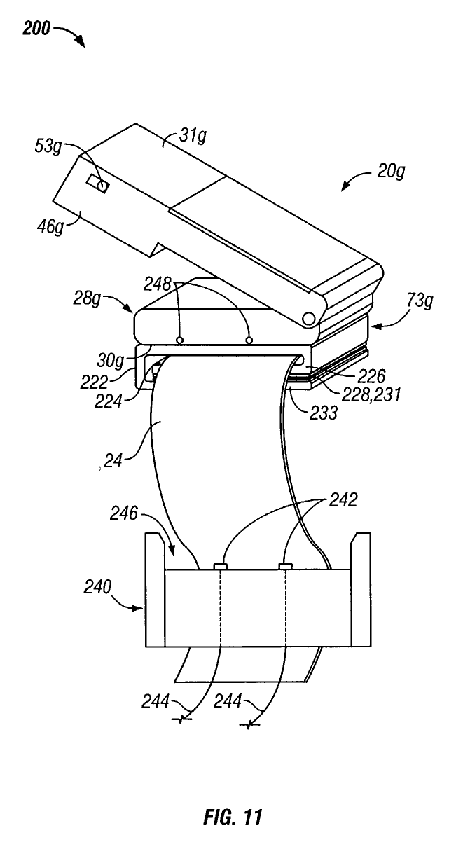

FIG. 11 is a schematic view of a seat belt light assembly 200. The assembly 200 comprises a light device 20g. In FIG. 11, elements of similar structure are designated by the same reference numeral followed by the lower case letter “g”. The light device 20g thus includes a pivotable main body 31g coupled to a base 28g. A light source 46gis included in the main body 31g and may be activated by a manual switch 53g, or, in the alternative, automatically switched on and off by the pivoting action of the main body 31g as previously discussed. A securing mechanism 73g coupled to a back side 30g of the base 28g is adapted to secure the device 20g onto a waist strap 24 of a standard automobile seat belt. The securing mechanism 73g may comprises a flexible strap 222 that defines a channel 224 which receives the waist strap 24. A first strap portion 226 may include a plurality of hooks 228 adapted to mate with a plurality of loops 231 formed on a second strap portion 233, such as a Velcro® device.

The assembly 200 includes a docking, or charging, station 240 of particular interest. The charging station 240 comprises station contacts 242 electrically coupled to wires 244 that, for example, may be coupled to the car battery. The station 240 includes a receptacle 246 that conforms to the external shape of the base 28g for a secure fit. In particular, the base 28g includes charging contacts 248 that are positioned to mate with the station contacts 242 when the light device 20g is coupled to the station 240. The station 240 may be rigidly fixed to the waist strap 24 at a particular position, or movable along the strap 24. The station 240 is preferably located adjacent to the waist strap 24 such that it does not get in the way of the driver.

Even though particular embodiments of the clip and light source have been illustrated in connection with certain preferred embodiments of the light device, it is to be expressly understood that a light device according to the invention may comprise any of the clips disclosed above or any other clip adapted to be coupled to a waist strap of a standard seat belt in combination with any of the other features disclosed in the preferred embodiments. It is to be further understood that a light device according to the invention may comprise a light source included in a pivotable main body or in a base, which light source may be in combination with any of the other features disclosed in the preferred embodiments.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what incorporates the essential idea of the invention.

What is claimed is:

1. A multi-purpose light device adapted for use by a user wearing an automobile seat belt, comprising:
a base configured to receive at least one battery;
a main body pivotally coupled to the base and movable between a closed position and an open position, the main body comprising a first side generally facing the base in the closed position and an opposite, second side generally facing away from the base in the closed position;
a light source included in the main body and configured to shine light from the first side; and
a clip configured to be secured to a vehicular seat belt.

2. The device of claim 1, wherein the light source comprises a light-emitting diode.

3. The device of claim 1, wherein the clip is integral with the base.

4. The device of claim 1, wherein the clip is removably coupled to the base.

5. The device of claim 1, wherein the clip defines a substantially rectangular, prismatic space for receiving the seat belt.

6. The device of claim 1, wherein the clip is configured to be permanently secured to the seat belt.

7. The device of claim 1, wherein the clip is configured to be removably secured to the seat belt.

8. The device of claim 1, wherein the main body comprises a picture frame disposed on the second side.

9. The device of claim 1, wherein the base further comprises a picture frame.

10. The device of claim 1, further comprising a switch included in the main body and configured to turn the light source on and off.

11. The device of claim 1, wherein the light source is configured to automatically turn on when the main body is not in the closed position and to automatically shut off when the main body is in the closed position.

12. The device of claim 1, wherein:
the base comprises a front side, a rear side, and an axis that extends between the front side and the rear side; and
the base is pivotable about the axis.

13. The device of claim 1, further comprising a recharging mechanism electrically coupled to a car battery and the battery housed in the base.

14. An automotive seat belt assembly, comprising:
an automobile seat belt including a waist strap; and
a light device coupled to the waist strap, the light device comprising a light source housed in a main body, the main body being pivotally movable between a closed position and a fully open position.

15. The assembly of claim 14, wherein the light device further comprises a clip coupled to the waist strap.

16. The assembly of claim 14, wherein the main body is configured to pivot upwardly from the closed position.

17. The assembly of claim 14, wherein the main body comprises a first side generally facing the waist strap when the main body is in the closed position and a second side generally facing away from the waist strap when the main body is in the closed position.

18. The assembly of claim 17, wherein the light source is configured to shine light from the first side.

19. The assembly of claim 17, wherein the main body includes a picture frame disposed on the second side.

20. The assembly of claim 14, wherein the light device further comprises a manually operable switch to switch the light source on and off.

21. The assembly of claim 14, wherein the light source is configured to automatically shut off when the main body is in the closed position, and configured to turn on the main body is not in the closed position.

22. The assembly of claim 14, further comprising an electrical charging mechanism including least one wire carried by the waist strap and electrically coupled to a car battery for providing electrical power to the light device.

23. The assembly of claim 22, wherein:
the light device houses a battery; and
the electrical charging mechanism recharges the battery.

24. The assembly of claim 22, wherein the light device is powered directly by the electrical charging mechanism.

25. The assembly of claim 22, wherein the electrical charging mechanism comprises a charging station.

26. The assembly of claim 25, wherein:
the charging station comprises at least one station contact;
the light device further comprises a base to which the main body is pivotally coupled; and
the base comprises a charging contact adapted to mate with the station contact when the light device is coupled to the charging station.

27. A multi-purpose light device adapted for use in connection with an automobile having a seat belt with a waist strap, comprising:
a base having a front side and a rear side, the base being configured to house at least one battery;
a light source included in the base and adapted to shine light from the front side;
a manual switch to turn the light source on and off; and
a securing mechanism to couple the base to the waist strap of the seat belt.

28. The device of claim 27, wherein the securing mechanism comprises a slotted clip.

29. The device of claim 27, wherein the securing mechanism comprises a wire clip.

30. The device of claim 27, wherein the securing mechanism comprises a spring loaded clip.

31. The device of claim 27, wherein:
the securing mechanism comprises a permanent clip; and
the base is removably coupled to the securing mechanism.

32. The device of claim 27, wherein the securing mechanism is integral with the base.

33. The device of claim 27, wherein the securing mechanism comprises a buckle having a first aperture and a second aperture.

34. A courtesy light device adapted for use within an automobile having a seat belt receptacle, comprising
a housing;
a goose-neck stand telescopically and incrementally extendable from the housing, the goose-neck comprising a first end substantially disposed within the housing and an opposite second end; and
a light source coupled to the second end of the goose-neck stand.

35. The light device of claim 34, wherein the housing is integral with the seat belt receptacle.

36. The light device of claim 34, wherein the housing is disposed adjacent to the seat belt receptacle.

37. A method of shining light in a cabin of an automobile having a seat belt with a waist strap, comprising:
coupling to the waist strap a housing having a first portion and a second portion;
disposing a light source in the second portion;
rotating the second portion away from the first portion; and
projecting light outwardly from the second portion.

38. The method of claim 37, wherein rotating the second portion away from the first portion comprises automatically turning on the light source.

39. The method of claim 35, further comprising:
rotating the second portion toward the first portion; and
automatically shutting off the light source when the second portion is rotated to a fully closed position.

40. The method of claim 34, further comprising:
manually turning the light source on; and
manually turning the light source off.

41. The method of claim 34, further comprising:
detaching the housing from the waist strap.

42. The method of claim 41, further comprising:
reattaching the housing to the waist strap.

43. The method of claim 37, further comprising:
rotating the second portion about an axis extending generally perpendicular to a rear side of the second portion.

44. The method of claim 37, further comprising:
electrically charging the light source with a car battery.

45. A method of shining light in a cabin of an automobile having a seat belt with a waist strap, comprising:
securing a light source to the waist strap;
turning the light source on;
projecting light outwardly from the waist strap; and
turning the light source off.

46. The method of claim 45, further comprising:
detaching the light source from the waist strap; and
projecting light in any direction.

47. The method of claim 46, further comprising:
reattaching the light source to the waist strap.
